(19) United States
(12) Patent Application Publication
(10) Pub. No.: US 2025/0388037 A1
(43) Pub. Date: Dec. 25, 2025

(54) MEDIUM TRANSPORT APPARATUS

(71) Applicant: SEIKO EPSON CORPORATION, TOKYO (JP)

(72) Inventors: Masato OGAWA, SHIOJIRI-SHI (JP); Hiroshi SHIOBARA, MATSUMOTO-SHI (JP); Hiroyuki MAEDA, MATSUMOTO-SHI (JP); Shintaro KOMURO, MATSUMOTO-SHI (JP); Koji HARA, MATSUMOTO-SHI (JP); Koki MURAKAMI, AGEMATSU-MACHI (JP); Yuki HARA, SHIOJIRI-SHI (JP); Masaki SHIMOMURA, MATSUMOTO-SHI (JP)

(21) Appl. No.: 19/243,892

(22) Filed: Jun. 20, 2025

(30) Foreign Application Priority Data
Jun. 20, 2024 (JP) 2024-099296

(51) Int. Cl. B41J 29/17; B41J 13/03; B41J 13/10; B65G 17/12

(52) U.S. Cl. CPC B41J 29/17; B41J 13/03; B41J 13/103; B65G 17/12

(57) ABSTRACT

A medium transport apparatus includes a medium housing unit configured to house a medium and to be inserted into and pulled out from an apparatus main body along first directions, a transport unit provided in one of the apparatus main body and the medium housing unit, having a rotation shaft along the first directions, and contacting the medium and transporting the medium in second directions, and a cleaning member provided in the other of the apparatus main body and the medium housing unit, and configured to contact the transport unit and clean the transport unit, wherein the transport unit and the cleaning member rub against each other as the transport unit and the cleaning member move relative to each other in conjunction with insertion and pullout of the medium housing unit into and from the apparatus main body.

The present application is based on, and claims priority from JP Application Serial Number 2024-099296, filed Jun. 20, 2024, the disclosure of which is hereby incorporated by reference herein in its entirety.

### BACKGROUND

### 1. Technical Field

The present disclosure relates to a medium transport apparatus.

### 2. Related Art

In related art, various medium transport apparatuses each including a medium housing unit and a transport unit and transporting a medium housed in the medium housing unit by the transport unit are used. Among the apparatuses, there is a medium transport apparatus in which a medium housing unit can be inserted into and pulled out from an apparatus main body. For example, JP-A-2002-211779 discloses a sheet feeding apparatus having a sheet feeding cassette as a medium housing unit that can be inserted into and pulled out from an apparatus main body and an adhesive member as a mechanism for cleaning a sheet feeding roller as a transport unit in conjunction with the insertion and the pullout of the sheet feeding cassette.

JP-A-2002-211779 is an example of the related art.

However, in the medium transport apparatus in related art, the transport unit may become dirty with, for example, paper dust or the like due to repeated transport of the medium. This also applies to a medium transport apparatus including a medium housing unit and a transport unit, in which the medium housing unit can be inserted into and pulled out from an apparatus main body, like the sheet feeding apparatus in JP-A-2002-211779. Here, in the sheet feeding apparatus of JP-A-2002-211779, the adhesive member comes into contact with the sheet feeding roller with the pullout of the sheet feeding cassette from the apparatus main body, and the cleaning performance is insufficient only by the adhesive member coming into contact with the sheet feeding roller.

### SUMMARY

A medium transport apparatus according to an aspect of the present disclosure includes a medium housing unit configured to house a medium and to be inserted into and pulled out from an apparatus main body along first directions, a transport unit provided in one of the apparatus main body and the medium housing unit, having a rotation shaft along the first directions, and contacting the medium and transporting the medium in second directions intersecting the first directions, and a cleaning member provided in the other of the apparatus main body and the medium housing unit, and configured to contact the transport unit and clean the transport unit, wherein the transport unit and the cleaning member rub against each other as the transport unit and the cleaning member move relative to each other in conjunction with insertion and pullout of the medium housing unit into and from the apparatus main body.

### BRIEF DESCRIPTION OF THE DRAWINGS

FIG. 1 is an internal configuration diagram of a recording apparatus as a medium transport apparatus according to Embodiment 1 of the present disclosure.

FIG. 2 is a plan view showing the internal configuration of the recording apparatus in FIG. 1, and illustrating a positional relationship between a transport unit and a cleaning member when a medium housing unit is inserted into an apparatus main body.

FIG. 3 is a plan view showing the internal configuration of the recording apparatus in FIG. 1, and illustrating a positional relationship between the transport unit and the cleaning member when the medium housing unit is pulled out from the apparatus main body.

FIG. 4 is a front view showing the internal the recording apparatus in configuration of FIG. 1, and illustrating a positional relationship between the transport unit and the cleaning member.

FIG. 5 is a front view showing an internal configuration of a recording apparatus as a medium transport apparatus according to Embodiment 2 of the present disclosure, and illustrating a positional relationship between a transport unit and a cleaning member.

FIG. 6 is a front view showing an internal configuration of a recording apparatus as a medium transport apparatus according to Embodiment 3 of the present disclosure, and illustrating a positional relationship between a transport unit and a cleaning member.

FIG. 7 is a plan view showing an internal FIG. configuration of a recording apparatus as a medium transport apparatus according to Embodiment 4 of the present disclosure, and illustrating a positional relationship between a transport unit and a cleaning member when a medium housing unit is inserted into an apparatus main body.

FIG. 8 is a perspective view showing a rotation mechanism of the transport unit of the recording apparatus in FIG. 7.

FIG. 9 is a plan view showing an internal configuration of a recording apparatus as a medium transport apparatus according to Embodiment 5 of the present disclosure, and illustrating a positional relationship between a transport unit and a cleaning member when a medium housing unit is inserted into an apparatus main body.

FIG. 10 is a plan view showing the internal configuration of the recording apparatus in FIG. 9, and illustrating a positional relationship between the transport unit and the cleaning member when the medium housing unit is pulled out from the apparatus main body.

### DESCRIPTION OF EMBODIMENTS

As below, the present disclosure will be schematically explained.

A medium transport apparatus according to a first embodiment of the present disclosure includes a medium housing unit configured to house a medium and to be inserted into and pulled out from an apparatus main body along first directions, a transport unit provided in one of the apparatus main body and the medium housing unit, having a rotation shaft along the first directions, and contacting the medium and transporting the medium in second directions intersecting the first directions, and a cleaning member provided in the other of the apparatus main body and the medium housing unit, and configured to contact the transport unit and clean the transport unit, wherein the transport unit and the cleaning member rub against each other as the transport unit and the cleaning member move relative to each other in conjunction with insertion and pullout of the medium housing unit into and from the apparatus main body.

According to the embodiment, the medium housing unit can be inserted into and pulled out from the apparatus main body along the first directions intersecting the second directions as transport directions of the medium, and the transport unit and the cleaning member rub against each other as the transport unit and the cleaning member move relative to each other in conjunction with insertion and pullout of the medium housing unit into and from the apparatus main body. According to the configuration, the relative movement distance between the transport unit and the cleaning member can be easily increased. That is, the transport unit and the cleaning member can be rubbed against each other over a long distance, not only simply coming into contact with each other, with the simple configuration. Since the transport unit and the cleaning member are rubbed against each other over a long distance, the transport unit is firmly cleaned by the cleaning member. Therefore, the cleaning performance for the transport unit can be improved with the simple configuration.

In a medium transport apparatus according to a second embodiment of the present disclosure according to the first embodiment, the transport unit is provided in the apparatus main body, and the cleaning member is provided in the medium housing unit.

According to the embodiment, in the configuration in which the transport unit is provided in the apparatus main body and the cleaning member is provided in the medium housing unit, the cleaning performance for the transport unit can be efficiently improved. Further, since the cleaning member can be taken out to the outside of the apparatus main body together with the medium housing unit, the cleaning member can be easily checked for dirt and replaced.

In a medium transport apparatus according to a third embodiment of the present disclosure according to the second embodiment, with reference to a state in which the medium housing unit is inserted into the apparatus main body, in the direction in which the medium housing unit is pulled out from the apparatus main body of the first directions, the cleaning member is provided posterior to the transport unit in the medium housing unit.

According to the embodiment, with reference to the state in which the medium housing unit is inserted into the apparatus main body, in the direction in which the medium housing unit is pulled out from the apparatus main body of the first directions, the cleaning member is provided posterior to the transport unit in the medium housing unit. According to the configuration, in the configuration in which the transport unit is provided in the apparatus main body and the cleaning member is provided in the medium housing unit, the transport unit and the cleaning member can be efficiently rubbed against each other over a long distance, and the cleaning performance for the transport unit can be efficiently improved.

In a medium transport apparatus according to a fourth embodiment of the present disclosure according to the third embodiment, when the medium housing unit is inserted into the apparatus main body, in the direction in which the medium housing unit is pulled out from the apparatus main body of the first directions, a length from a center of the transport unit to a posterior end portion of the cleaning member is longer than a length from the center of the transport unit to a posterior end portion of a medium housing range of the medium housing unit.

According to the embodiment, when the medium housing unit is inserted into the apparatus main body, in the direction in which the medium housing unit is pulled out from the apparatus main body of the first directions, the length from the center of the transport unit to the posterior end portion of the cleaning member is longer than the length from the center of the transport unit to the posterior end portion of the medium housing range of the medium housing unit. Therefore, the relative movement distance between the transport unit and the cleaning member can be particularly increased, and the cleaning performance for the transport unit can be particularly efficiently improved.

In a medium transport apparatus according to a fifth embodiment of the present disclosure according to the first embodiment, the transport unit is provided in the medium housing unit, the cleaning member is provided in the apparatus main body, and, with reference to a state in which the medium housing unit is inserted into the apparatus main body, in the direction in which the medium housing unit is pulled out from the apparatus main body of the first directions, the cleaning member is provided anterior to the transport unit.

According to the embodiment, the transport unit is provided in the medium housing unit, the cleaning member is provided in the apparatus main body, and, with reference to the state in which the medium housing unit is inserted into the apparatus main body, in the direction in which the medium housing unit is pulled out from the apparatus main body of the first directions, the cleaning member is provided anterior to the transport unit. According to the configuration, in the configuration in which the transport unit is provided in the medium housing unit and the cleaning member is provided in the apparatus main body, the transport unit and the cleaning member can be efficiently rubbed against each other over a long distance, and the cleaning performance for the transport unit can be efficiently improved.

In a medium transport apparatus according to a sixth embodiment of the present disclosure according to any one of the third to fifth embodiments, when the medium housing unit is inserted into the apparatus main body, the transport unit and the cleaning member are provided at positions not overlapping each other as seen from third directions intersecting both the first directions and the second directions, and the transport unit and the cleaning member are provided at positions overlapping each other as seen from the first directions.

According to the embodiment, when the medium housing unit is inserted into the apparatus main body, the transport unit and the cleaning member are provided at the positions not overlapping each other as seen from the third directions, and the transport unit and the cleaning member are provided at the positions overlapping each other as seen from the first directions. According to the configuration, the transport unit and the cleaning member can be brought into contact with and separated from each other only by the attachment and detachment operation of the medium housing unit to and from the apparatus main body, and thereby, both the cleaning of the transport unit and the transport of the medium can be performed with the simple configuration without using a mechanism that can move the cleaning member in directions different from the first directions. In addition, the transport unit and the cleaning member can be efficiently rubbed against each other over a long distance, and the cleaning performance for the transport unit can be efficiently improved.

In a medium transport apparatus according to a seventh embodiment of the present disclosure according to any one of the first to sixth embodiments, a length of the cleaning member in the first directions is longer than a length of the cleaning member in the second directions.

According to the embodiment, the length of the cleaning member in the first directions is longer than the length of the cleaning member in the second directions. Therefore, the relative moving distance between the transport unit and the cleaning member can be increased, and the cleaning performance for the transport unit can be efficiently improved.

In a medium transport apparatus according to an eighth embodiment of the present disclosure according to any one of the first to seventh embodiments, the cleaning member has a plurality of contact surfaces as seen from the first directions, and is configured to contact the transport unit at the plurality of contact surfaces.

According to the embodiment, the cleaning member is configured to contact the transport unit at the plurality of contact surfaces. The plurality of contact surfaces are brought into contact with the transport unit, and thereby, the cleaning performance for the transport unit can be efficiently improved.

In a medium transport apparatus according to a ninth embodiment of the present disclosure according to any one of the first to seventh embodiments, the cleaning member has a contact surface having a curved surface shape conforming to the transport unit as seen from the first directions.

According to the embodiment, the cleaning member has the contact surface having the curved surface shape conforming to the transport unit as seen from the first directions. As described above, the cleaning member has the contact surface having the curved surface shape conforming to the transport unit, and thereby, the cleaning performance for the transport unit can be efficiently improved.

A medium transport apparatus according to a tenth embodiment of the present disclosure according to any one of the first to ninth embodiments includes a rotation mechanism that rotates the transport unit in conjunction with the insertion and the pullout of the medium housing unit into and from the apparatus main body.

According to the embodiment, the rotation mechanism that rotates the transport unit in conjunction with insertion and pullout of the medium housing unit into and from the apparatus main body is provided. According to the configuration, the transport unit can be rotated and rubbed efficiently against the cleaning member while rotating the transport unit, and thereby, the cleaning performance for the transport unit can be efficiently improved.

In a medium transport apparatus according to an eleventh embodiment of the present disclosure according to any one of the first to tenth embodiments, the transport unit is a retard roller forming a roller pair together with a feed roller that feeds the medium and separating the multiple-feed medium together with the feed roller.

According to the embodiment, the transport unit is a retard roller forming a roller pair together with a feed roller that feeds the medium and separating the multiple-feed medium together with the feed roller. According to the configuration, in the configuration in which the transport unit is the retard roller, the cleaning performance for the transport unit can be efficiently improved.

### Embodiment 1

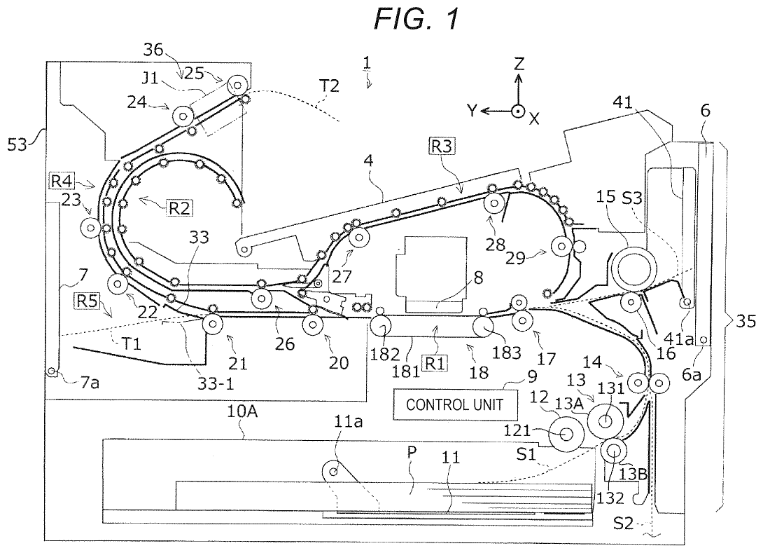

As below, the present disclosure will be specifically described. First, a recording apparatus 1 of Embodiment 1 as an example of a medium transport apparatus of the present disclosure will be described with reference to FIGS. 1 to 4. In an X-Y-Z coordinate system shown in each drawing, X-axis directions refer to frontward and backward directions of the apparatus and medium width directions, Y-axis directions refer to lateral directions of the apparatus, and Z-axis directions refer to a height direction of the apparatus and a gravity direction. Incidentally, a direction in which a medium P is transported is referred to as “downstream”, and the opposite direction thereto is referred to as “upstream”. In the individual drawings, part of component members may be omitted or simplified for clarity of an internal configuration and the like.

First, an outline of the recording apparatus 1 of the embodiment is described with reference to FIG. 1. As shown in FIG. 1, the recording apparatus 1 of the embodiment includes an ejection tray 4 that receives the ejected medium P with an image recorded thereon. Further, the printing apparatus 1 includes an opening/closing cover 6, and the opening/closing cover 6 is configured to be swingable around a swing shaft 6a and can open and close by swinging around the swing shaft 6a. A manual feed tray 41 is provided inside the opening/closing cover 6. The manual feed tray 41 rotates around a swing shaft 41a and can open and close together with the opening/closing cover 6.

The recording apparatus 1 includes three medium feeding routes of a feeding route from a medium cassette 10A corresponding to a cassette feeding track S1, a feeding route from an additional cassette (not shown) corresponding to an additional cassette feeding track S2, and a feeding route from the manual feed tray 41, on which the medium P is placed, corresponding to a manual feeding route S3. The recording apparatus 1 has two medium ejection methods of face-up ejection corresponding to a face-up ejection track T1 for ejecting the medium with a first surface on which recording is most recently performed facing upward and face-down ejection corresponding to a face-down ejection track T2 for ejecting the medium with the first surface facing downward.

The recording apparatus 1 includes a face-up ejection tray 7 that receives the medium P to be ejected face-up. The face-up ejection tray 7 can take a storage state shown in FIG. 1 and an open state (not shown) by pivoting around a pivot shaft 7a. Further, the recording apparatus 1 includes five medium transport routes of a recording transport route R1, a switchback route R2, an inversion route R3, a face-down ejection route R4, and a face-up ejection route R5.

The recording apparatus 1 includes a flap 33 as a route switching member driven by a drive source (not shown), and switches between a state indicated by a solid line in FIG. 1 and a state indicated by a virtual line of a flap 33-1. When the flap 33 is in the state indicated by the solid line in FIG. 1, the medium P is guided to the face-down ejection route R4 and ejected face-down as indicated by the face-down ejection track T2. The most downstream part of the face-down ejection route R4 includes an ejection mechanism unit 36. In a region J1 in FIG. 1, spurs as a plurality of driven rollers are provided. When the flap 33 is in the state of the virtual line in FIG. 1, the medium P is guided to the face-up ejection route R5 and is ejected face-up as indicated by the face-up ejection track T1.

A control unit 9 for various types of control acquires recording data as data for recording generated by a printer driver operating in an external computer (not shown) or a printer driver provided in the control unit 9. The control unit controls the inkjet type recording head 8, various medium transport rollers driven by a motor (not shown), flaps as respective route switching members, and the like based on the recording data. The control unit 9 performs necessary control based on detected states of various sensors such as a sensor that detects a passage of the medium P, for example. In FIG. 1, the control unit 9 is conceptually illustrated and, in practice, includes a circuit board provided at a predetermined position in an apparatus main body 35.

Here, a medium feeding route to a resist roller pair 17 is described. The medium cassette 10A detachably provided in the apparatus main body 35 includes a hopper 11, the hopper 11 swings around a shaft 11a, and thereby, the medium P housed in the medium cassette 10A comes into contact with and separates from a feeding roller 12 that is rotationally driven by a motor (not shown). The details of the medium cassette 10A will be described later.

The medium P fed from the medium cassette 10A by the feeding roller 12 passes through the nip position and is separated by a separation roller pair 13 to prevent multi-feed, and reaches the resist roller pair 17 by a feeding force from a transport roller pair 14. The separation roller pair 13 includes a feed roller 13A and a retard roller 13B. When the media P are multiple-feed to the separation roller pair 13, the feed roller 13A rotates to transport only the uppermost medium P, but the retard roller 13B does not rotate together with the feed roller 13A to suppress the transport of the media P lower than the uppermost medium P.

Similarly, an additional cassette (not shown) located below the apparatus main body 35 includes a feeding roller 12 and a separation roller pair 13, and the medium P fed from each additional cassette reaches the resist roller pair 17 by a feeding force from the transport roller pair 14 shown in FIG. 1. A feed roller 15 and a separation roller 16 are provided in a manual feed route S3 as a medium feed route from the manual feed tray 41, and the medium P set on the manual feed tray 41 reaches the resist roller pair 17 by rotation of these rollers.

In the medium transport route, the resist roller pair 17, transport roller pairs 20 to 24, transport roller pairs 26 to 29, and an ejection roller pair 25 as an ejection unit that ejects the medium P are provided. The ejection roller pair 25 provided in the most downstream part of the face-down ejection route R4 forms the ejection unit that ejects the medium P from the face-down ejection route R4.

Each roller pair includes a driving roller driven by a motor (not shown) and a driven roller that can nip the medium P between the driving roller and itself and is driven to rotate in contact with the medium P. The recording transport route R1 as a first transport route passes below the recording head 8 as a recording unit that performs recording on the medium P, and extends upstream and downstream thereof. In the recording transport route R1, the medium P is subjected to a feeding force from the resist roller pair 17 and a belt unit 18. The belt unit 18 includes an electrostatic adsorption belt 181 that transports the medium P, and a driving roller 182 and a driven roller 183 around which the electrostatic adsorption belt 181 is wound.

The recording head 8 of the embodiment is a so-called line head in which nozzles for ejecting ink are provided to cover the entire part of the medium in its width directions, and is configured as a recording head that can record on the entire part of the medium in its width directions without moving in the medium width directions. However, the recording unit is not limited to the line head as long as the recording unit ejects a liquid such as ink onto the medium P to record. Further, a recording unit recording using toner may be provided instead of the recording unit that ejects liquid ink.

The switchback route R2 as a second transport route is a transport route coupled to the recording transport route R1 for feeding the medium P passing below the recording head 8 in the leftward direction in FIG. 1, then, switching back, and transporting in the rightward direction in FIG. 1 as a direction opposite to the feeding direction, and the route is located inside of a curve with respect to the face-down ejection route R4, which will be described later. In the switchback route R2, the medium P is subjected to a feeding force from the transport roller pair 26.

The inversion route R3 as a third transport route is a transport route coupled to the switchback route R2, inverts the medium P transported in the opposite direction as the rightward direction in FIG. 1 by bypassing the recording head 8 at the upside thereof and, in the embodiment, joins the medium P at a position upstream the recording head 8 in the recording transport route R1, which is a position upstream the resist roller pair 17. In the inversion route R3, the medium P is subjected to a feeding force from the transport roller pairs 27, 28, and 29.

The face-down ejection route R4 as a fourth transport route is a transport route coupled to the recording transport route R1 for curving the medium P passing below the recording head 8 with the surface facing the recording head 8 inside, inverting and ejecting the medium. In the face-down ejection route R4, the medium P is subjected to a feeding force from the transport roller pairs 20, 21, 22, 23, and 24 and the ejection roller pair 25. The most downstream part of the face-down ejection route R4 includes the ejection mechanism unit 36 as described above. A flap as a route switching member for switching the transport route is provided in the coupling portion of each transport route. The flap sets a route along which the medium P travels.

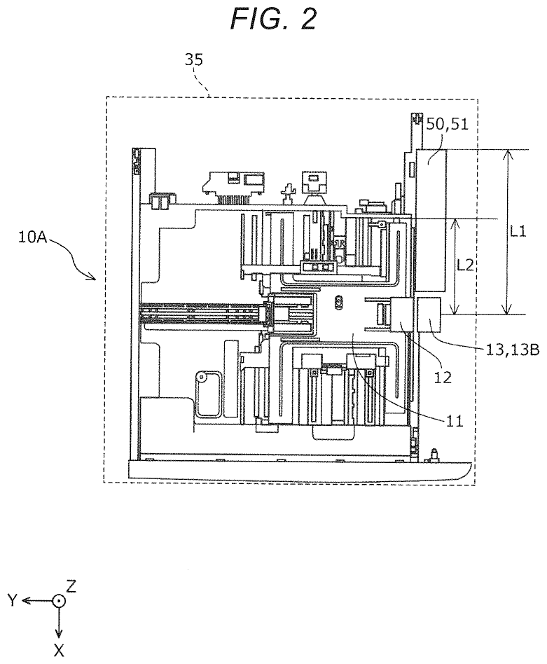

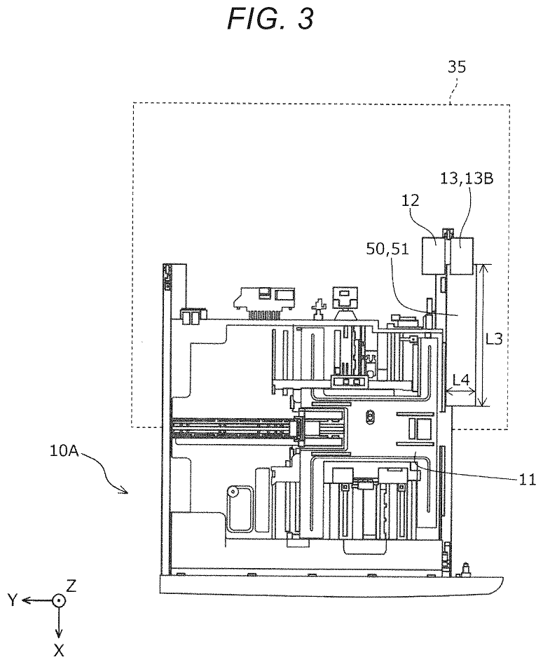

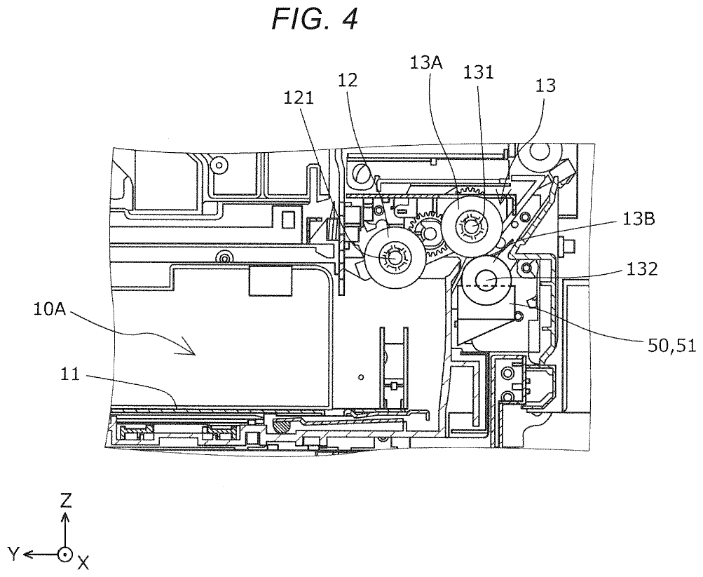

Next, the details of the medium cassette 10A of the recording apparatus 1 of the embodiment will be described with reference to FIGS. 2 to 4. The medium cassette 10A of the embodiment is a medium housing unit that can house the medium P and can be inserted into and pull out from the apparatus main body 35 along first directions corresponding to the X-axis directions. As shown in FIGS. 2 and 3, in the recording apparatus 1 of the embodiment, the feeding roller 12 and the separation roller pair 13 forming a transport unit for the medium P are provided in the apparatus main body 35. As shown in FIGS. 2 and 4, the feeding roller 12 and the separation roller pair 13 can contact the medium P and transport the medium P in second directions substantially corresponding to the Y-axis directions intersecting the X-axis directions, and have rotation shafts 121, 131, and 132 along the first directions.

Here, as shown in FIGS. 2 to 4, the medium cassette 10A is provided with a rectangular brush 51 as a cleaning member 50 that can contact with the retard roller 13B of the separation roller pair 13 as the transport unit and clean the retard roller 13B. The recording apparatus 1 of the embodiment is configured such that the retard roller 13B and the cleaning member 50 rub against each other as the retard roller 13B and the cleaning member move relative to each other in conjunction with the insertion and the pullout of the medium cassette 10A into and from the apparatus main body 35. When the medium cassette 10A is pulled out from the apparatus main body 35, the retard roller 13B slightly moves in a direction away from the feed roller 13A at the moment when the medium cassette 10A is pulled out from the apparatus main body 35 to prevent the retard roller 13B and the feed roller 13A from rubbing against each other.

Deposits such as paper dust are likely to adhere to the retard roller 13B forming the separation roller pair 13 via the medium P. However, the recording apparatus 1 of the embodiment has the above described configuration, and thus it is easy to increase the relative movement distance of the retard roller 13B to be cleaned to the cleaning member 50. That is, in the recording apparatus 1 of the embodiment, the retard roller 13B and the rectangular brush 51 as the cleaning member 50 can be rubbed against each other over a long distance, not only simply coming into contact with each other, with the simple configuration. Since the retard roller 13B and the rectangular brush 51 are rubbed against each other over a long distance, the retard roller 13B is firmly cleaned by the rectangular brush 51. Therefore, the recording apparatus 1 of the embodiment can improve the cleaning performance for the retard roller 13B with the simple configuration.

In the recording apparatus 1 of the embodiment, the retard roller 13B is provided in the apparatus main body 35, and the cleaning member 50 is provided in the medium cassette 10A. That is, in the recording apparatus 1 of the embodiment, in the configuration in which the transport unit is provided in the apparatus main body and the cleaning member is provided in the medium housing unit, the cleaning performance for the transport unit can be improved. Further, according to the configuration, since the cleaning member can be taken out to the outside of the apparatus main body together with the medium housing unit, the cleaning member can be easily checked for dirt and replaced.

Here, as shown in FIG. 2, with reference to the state in which the medium cassette 10A is inserted into the apparatus main body 35, in the +X direction corresponding to the direction in which the medium cassette 10A is pulled out from the apparatus main body 35 of the first directions corresponding to the X-axis directions, the cleaning member 50 is provided posterior to the retard roller 13B (at the side in the −X direction) in the medium cassette 10A. According to the configuration, in the recording apparatus 1 of the embodiment, in the configuration in which the transport unit is provided in the apparatus main body and the cleaning member is provided in the medium housing unit, the retard roller 13B as the transport unit and the rectangular brush 51 can be efficiently rubbed against each other over a long distance, and the cleaning performance for the retard roller 13B as the transport unit can be efficiently improved.

Further, as shown in FIG. 2, in the recording apparatus 1 of the embodiment, when the medium cassette 10A is inserted into the apparatus main body 35, in the +X direction, a length L1 from the center of the retard roller 13B to the posterior end portion of the rectangular brush 51 of the cleaning member 50 is longer than a length L2 from the center of the rectangular brush 51 to the posterior end portion of a medium housing range of the medium cassette 10A. Here, the medium housing range is a range in which the medium P that can be recorded by the recording apparatus 1 and can be housed in the recording apparatus 1 is housed. According to the configuration, in the recording apparatus 1 of the embodiment, the relative movement distance between the retard roller 13B as the transport unit and the cleaning member 50 can be particularly increased, and the cleaning performance for the retard roller 13B as the transport unit can be particularly efficiently improved.

Furthermore, as shown in FIG. 2, in the recording apparatus 1 of the embodiment, when the medium cassette 10A is inserted into the apparatus main body 35, the retard roller 13B and the rectangular brush 51 of the cleaning member 50 are provided at positions not overlapping each other as seen from third directions corresponding to the Z-axis directions intersecting both the first directions corresponding to the X-axis directions and the second directions corresponding to the Y-axis directions. As shown in FIG. 4, the retard roller 13B and the rectangular brush 51 of the cleaning member 50 are provided at positions overlapping each other as seen from the X-axis directions corresponding to the first directions.

According to the configuration, in the recording apparatus 1 of the embodiment, the retard roller 13B and the rectangular brush 51 can be brought into contact with and separated from each other only by the attachment and detachment operation of the medium cassette 10A to and from the apparatus main body 35, and thereby, both the cleaning of the retard roller 13B and the transport of the medium P can be performed with the simple configuration without using a mechanism that can move the cleaning member 50 in directions different from the first directions. According to the configuration, the retard roller 13B and the rectangular brush 51 can be efficiently rubbed together over a long distance, and the cleaning performance for the retard roller 13B can be efficiently improved.

As shown in FIG. 3, in the recording apparatus 1 of the embodiment, a length L3 of the rectangular brush 51 of the cleaning member 50 in the first directions corresponding to the X-axis directions is longer than a length L4 in the second directions corresponding to the Y-axis directions. Therefore, in the recording apparatus 1 of the embodiment, the relative movement distance between the retard roller 13B and the cleaning member 50 can be increased, and the cleaning performance for the retard roller 13B can be efficiently improved.

As described above, in the recording apparatus 1 of the embodiment, the transport unit to be cleaned is the retard roller 13B forming the separation roller pair 13 together with the feed roller 13A that feeds the medium P and separating the multiple-feed medium P together with the feed roller 13A. According to the configuration, in the configuration in which the transport unit is the retard roller, the cleaning performance for the transport unit can be efficiently improved.

### Embodiment 2

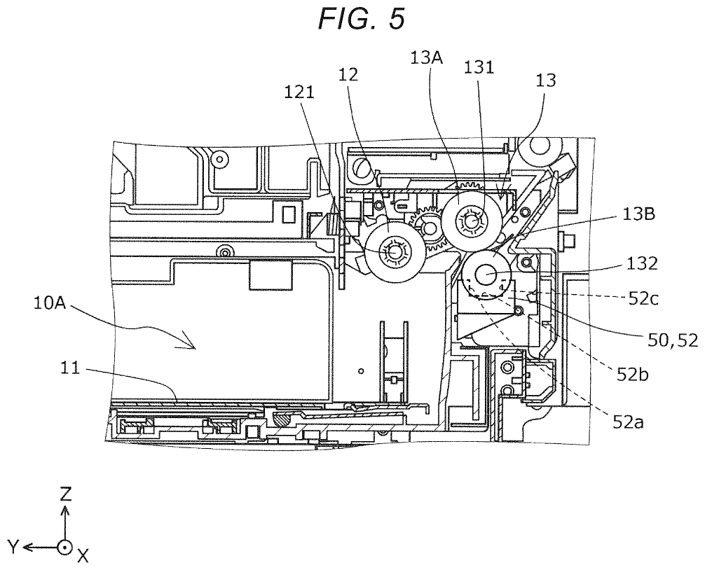

Next, a recording apparatus according to Embodiment 2 will be described with reference to FIG. 5. In FIG. 5, the component members in common with the above described Embodiment 1 have the same signs and the detailed explanation thereof will be omitted. FIG. 5 corresponds to FIG. 4 in the recording apparatus 1 of Embodiment 1. Here, the recording apparatus of the embodiment has the same configuration as the recording apparatus 1 of Embodiment 1 except for the configuration of the cleaning member 50. Accordingly, the recording apparatus of the embodiment has the same characteristics as those of the recording apparatus 1 of Embodiment 1 except for the portions described below.

As shown in FIG. 5, in the recording apparatus of the embodiment, the cleaning member 50 is a bent brush 52 bent as seen from the first directions corresponding to the X-axis directions and can come into contact with the retard roller 13B as the transport unit at a plurality of contact surfaces 52a, 52b, and 52c. The plurality of contact surfaces are brought into contact with the transport unit, and thereby, the cleaning performance for the transport unit can be efficiently improved.

The bent brush 52 of the embodiment is bent in two locations as seen from the first directions corresponding to the X-axis directions into a U-shape. However, the bent brush is not limited to the configuration, and may be bent in one location as Seen from the first directions corresponding to the X-axis directions into an L-shape, or may be bent at three or more locations as seen from the first directions corresponding to the X-axis directions.

### Embodiment 3

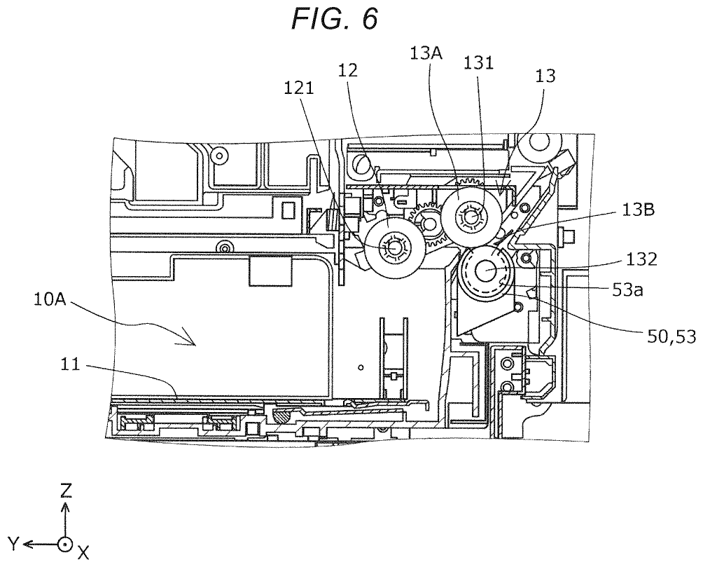

Next, a recording apparatus of Embodiment 3 will be described with reference to FIG. 6. In FIG. 6, the component members in common with the above described Embodiment 1 and Embodiment 2 have the same signs and the detailed explanation thereof will be omitted. FIG. 6 corresponds to FIG. 4 in the recording apparatus 1 of Embodiment 1. Here, the recording apparatus of the embodiment has the same configuration as the recording apparatus of Embodiment 1 except for the configuration of the cleaning member 50. Accordingly, the recording apparatus of the embodiment has the same characteristics as those of the recording apparatus 1 of Embodiment 1 except for the portions described below.

As shown in FIG. 6, in the recording apparatus of the embodiment, the cleaning member 50 is a cylindrical brush 53 having a contact surface 53a in a curved surface shape conforming to the retard roller 13B as the transport unit as seen from the first directions corresponding to the X-axis directions. As described above, the cleaning member 50 has the contact surface having the curved surface shape conforming to the transport unit, and thereby, the cleaning performance for the transport unit can be efficiently improved.

### Embodiment 4

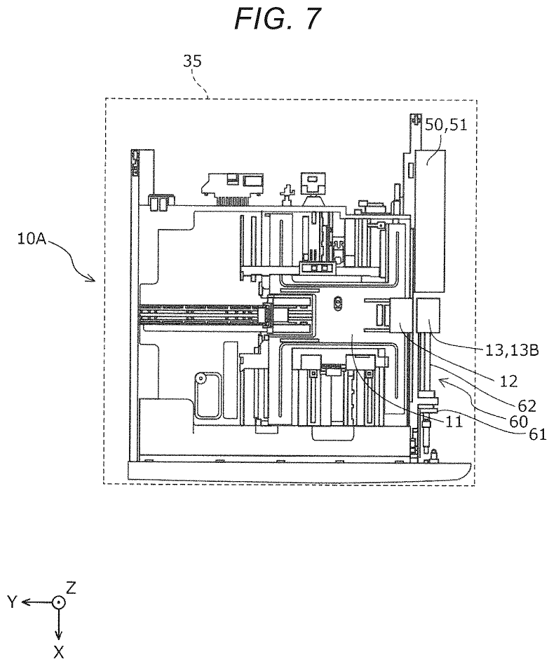

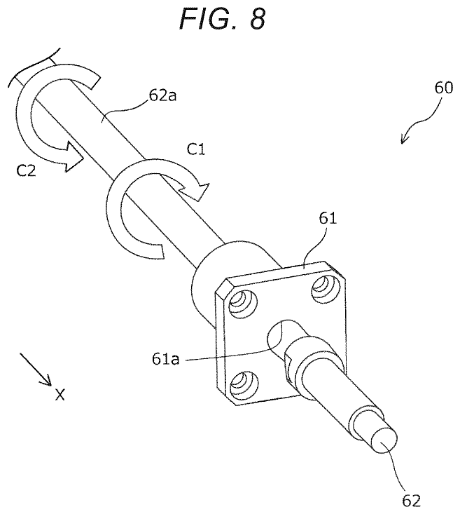

Next, a recording apparatus of Embodiment 4 will be described with reference to FIGS. 7 and 8. In FIGS. 7 and 8, the component members in common with the above described Embodiment 1 to Embodiment 3 have the same signs and the detailed explanation thereof will be omitted. FIG. 7 corresponds to FIG. 2 in the recording apparatus 1 of Embodiment 1. Here, the recording apparatus of the embodiment has the same configuration as that of the recording apparatus 1 of the first embodiment except that a rotation mechanism of the retard roller 13B is provided. Accordingly, the recording apparatus of the embodiment has the same characteristics as those of the recording apparatus 1 of Embodiment 1 except for the portions described below.

As shown in FIG. 7, in the recording apparatus of the embodiment, a rotation mechanism 60 that rotates the retard roller 13B in conjunction with the insertion and the pullout of the medium cassette 10A into and from the apparatus main body 35 is provided. According to the configuration, in the recording apparatus of the embodiment, the retard roller 13B as the transport unit can be rotated and efficiently rubbed against the rectangular brush 51 as the cleaning member 50, and thereby, the cleaning performance for the transport unit can be efficiently improved.

Here, the detailed configuration of the rotation mechanism 60 is described. The rotation mechanism 60 includes a fixation portion 61 fixed to the medium cassette 10A. The fixation portion 61 is provided with a female thread 61a. The rotation mechanism 60 includes a shaft portion 62 inserted into the female thread 61a. The shaft portion 62 is provided with a male thread 62a, and the male thread 62a is fitted in the female thread 61a of the fixation portion 61. When the male thread 62a rotates with respect to the female thread 61a in conjunction with the insertion and the pullout of the medium cassette 10A into and from the apparatus main body 35, the shaft portion 62 rotates in rotation directions C1 and C2. The shaft portion 62 is coupled to the retard roller 13B, and the retard roller 13B rotates as the shaft portion 62 rotates.

### Embodiment 5

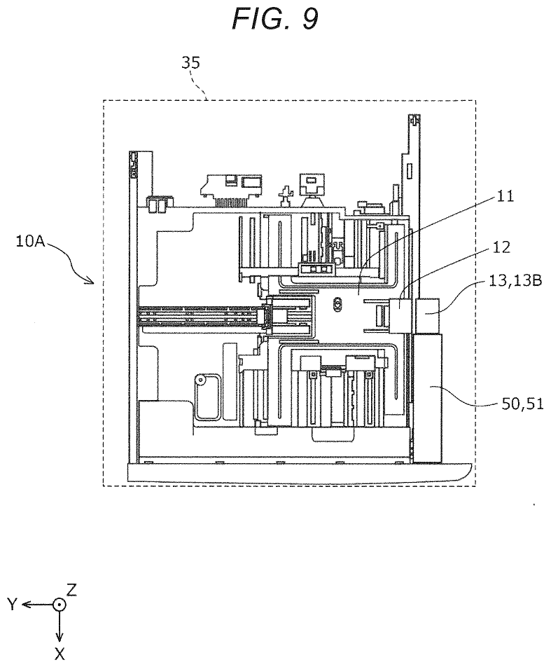

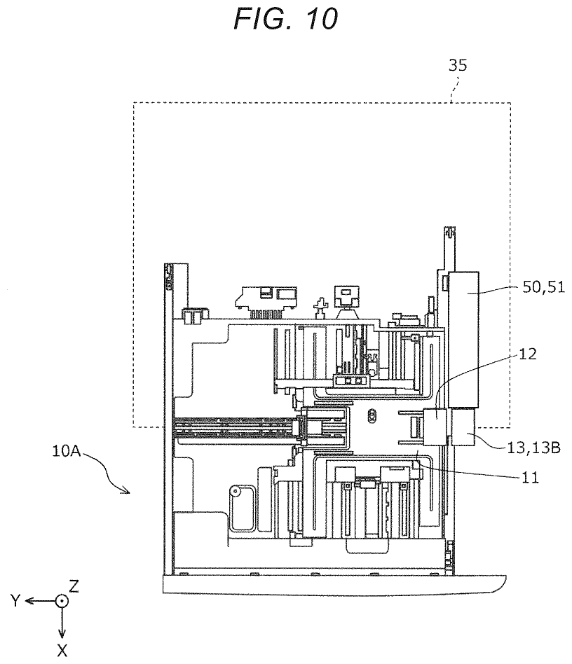

Next, a recording apparatus of Embodiment 5 will be described with reference to FIGS. 9 and 10. In FIGS. 9 and 10, the component members in common with the above described Embodiment 1 to Embodiment 4 have the same signs and the detailed explanation thereof will be omitted. FIG. 9 corresponds to FIG. 2 in the recording apparatus 1 of Embodiment 1, and FIG. 10 corresponds to FIG. 3 in the recording apparatus 1 of Embodiment 1. Here, the recording apparatus of the embodiment has the same configuration as the recording apparatus 1 of Embodiment 1 except for the arrangement of the feeding roller 12 and the separation roller pair 13 as the transport unit, and the cleaning member 50. Accordingly, the recording apparatus of the embodiment has the same characteristics as those of the recording apparatus 1 of Embodiment 1 except for the portions described below.

As described above, the recording apparatus 1 of Embodiment 1 has the configuration in which the feeding roller 12 and the separation roller pair 13 as the transport unit are provided in the apparatus main body 35, and the cleaning member 50 is provided in the medium cassette 10A as the medium housing unit. However, in the present disclosure, the cleaning member may be provided in the apparatus main body, and the transport unit may be provided in the medium housing unit. The recording apparatus of the embodiment has the configuration in which the cleaning member is provided in the apparatus main body and the transport unit is provided in the medium housing unit. Specifically, as shown in FIG. 9, with reference to the state in which the medium cassette 10A is inserted into the apparatus main body 35, in the +X direction as the direction in which the medium cassette 10A is pulled out from the apparatus main body 35 of the first directions corresponding to the X-axis directions, the cleaning member 50 is provided anterior to the retard roller 13B (at the side in the +X direction). According to the configuration, in the configuration in which the transport unit is provided in the medium housing unit and the cleaning member is provided in the apparatus main body, the transport unit and the cleaning member can be efficiently rubbed against each other over a long distance, and the cleaning performance for the transport unit can be efficiently improved.

The present disclosure is not limited to the above described embodiments and modifications. Various modifications can be made within the scope of the disclosure set forth in What is claimed is. It is obvious that the modifications also fall within the scope of the present disclosure. For example, the recording apparatus may have a symmetrical configuration as seen from the front side with respect to the recording apparatus of each of the above described embodiments. Further, a configuration in which the medium cassette 10A is coupled to a generator and power can be generated along with the insertion and the pullout of the medium cassette 10A into and from the apparatus main body 35 may be employed. According to the configuration, the generated electricity can be used as power for separating the retard roller 13B from the feed roller 13A, power for rotating the retard roller 13B when the medium cassette 10A is pulled out from the apparatus main body 35, or the like.

What is claimed is:

1. A medium transport apparatus comprising:
a medium housing unit configured to house a medium and to be inserted into and pulled out from an apparatus main body along first directions;
a transport unit provided in one of the apparatus main body and the medium housing unit, having a rotation shaft along the first directions, and contacting the medium and transporting the medium in second directions intersecting the first directions; and
a cleaning member provided in another of the apparatus main body and the medium housing unit, and configured to contact the transport unit and clean the transport unit, wherein
the transport unit and the cleaning member rub against each other as the transport unit and the cleaning member move relative to each other in conjunction with insertion and pullout of the medium housing unit into and from the apparatus main body.

2. The medium transport apparatus according to claim 1, wherein
the transport unit is provided in the apparatus main body, and
the cleaning member is provided in the medium housing unit.

3. The medium transport apparatus according to claim 2, wherein
with reference to a state in which the medium housing unit is inserted into the apparatus main body, in the direction in which the medium housing unit is pulled out from the apparatus main body of the first directions, the cleaning member is provided posterior to the transport unit in the medium housing unit.

4. The medium transport apparatus according to claim 3, wherein
when the medium housing unit is inserted into the apparatus main body, in the direction in which the medium housing unit is pulled out from the apparatus main body of the first directions, a length from a center of the transport unit to a posterior end portion of the cleaning member is longer than a length from the center of the transport unit to a posterior end portion of a medium housing range of the medium housing unit.

5. The medium transport apparatus according to claim 1, wherein
the transport unit is provided in the medium housing unit,
the cleaning member is provided in the apparatus main body, and
with reference to a state in which the medium housing unit is inserted into the apparatus main body, in the direction in which the medium housing unit is pulled out from the apparatus main body of the first directions, the cleaning member is provided anterior to the transport unit.

6. The medium transport apparatus according to claim 3, wherein
when the medium housing unit is inserted into the apparatus main body, the transport unit and the cleaning member are provided at positions not overlapping each other as seen from third directions intersecting both the first directions and the second directions, and the transport unit and the cleaning member are provided at positions overlapping each other as seen from the first directions.

7. The medium transport apparatus according to claim 1, wherein
a length of the cleaning member in the first directions is longer than a length of the cleaning member in the second directions.

8. The medium transport apparatus according to claim 1, wherein
the cleaning member has a plurality of contact surfaces as seen from the first directions, and is configured to contact the transport unit at the plurality of contact surfaces.

9. The medium transport apparatus according to claim 1, wherein
the cleaning member has a contact surface having a curved surface shape conforming to the transport unit as seen from the first directions.

10. The medium transport apparatus according to claim 1, further comprising a rotation mechanism that rotates the transport unit in conjunction with the insertion and the pullout of the medium housing unit into and from the apparatus main body.

11. The medium transport apparatus according to claim 1, wherein
the transport unit is a retard roller forming a roller pair together with a feed roller that feeds the medium and separating the multiple-feed medium together with the feed roller.
